(19) United States
(12) Patent Application Publication
(10) Pub. No.: US 2006/0248648 A1
(43) Pub. Date: Nov. 9, 2006

(54) Treatment couch

(76) Inventor: Erich Kratzmaier, Eurasburg (DE)

Correspondence Address: WOOD, PHILLIPS, KATZ, CLARK & MORTIMER, 500 W. MADISON STREET, SUITE 3800, CHICAGO, IL, 60661, US

(21) Appl. No.: 10/565,093

(22) PCT Filed: Jul. 16, 2004
(86) PCT No.: PCT/EP04/51525

§ 371 Date: Jun. 14, 2006

(30) Foreign Application Priority Data
Jul. 18, 2003 (EP) 03016295.2
Jul. 18, 2003 (EP) 03016296.0

(51) Int. Cl. A61G 7/00

(52) U.S. Cl. 5/600; 5/621

(57) ABSTRACT

The invention relates to a treatment couch for accommodation of a patient, comprising a lying surface (1), for the patient and a base (4), for supporting the lying surface (1) on a floor (6), whereby the lying surface (1) may be adjusted relative to the base (4) along a Y-direction parallel to the longitudinal direction thereof, a horizontal X-direction perpendicular thereto and a vertical Z-direction, in order to adjust the lying position of the patient, characterised in that, on adjusting the lying surface (1), the same is pivoted about a rotational axis (13, 19) perpendicular to the Y-direction. The invention further relates to a treatment couch for accommodating a patient provided with a headrest for the head of the patient, whereby a drive for the vertical adjustment of the headrest is inbuilt, such that the headrest may be removed as a module with the drive.

The present invention relates to a treatment berth which is to be understood as any kind of treatment supports without limitation, as beds, tables and the like, for supporting the body of patients during a treatment.

Such treatment berths principally comprise a berth board for the patient and a basis to support the berth board on a floor, e. g. in a treatment room. A berth board can of course be upholstered and thus needs not necessarily be a rigid board in a literal sense. Further, the berth board can comprise multiple parts, of course, e. g. be comprised of various board like elements.

Such treatments berths are adjustable in multiple senses in some cases in order to adequately position the patient. The invention relates to a treatment berth being adjustable in at least two substantially perpendicular senses of adjustment.

Contemplated are especially adjustment senses along a longitudinal direction of the berth board, along a horizontal direction transverse thereto, and finally along a vertical direction. For simplicity, these directions are named X, Y, and Z in the following, where Y represents the longitudinal direction, X the horizontal direction substantially transverse thereto, and Z the vertical direction.

It is an object of the present invention to provide a treatment berth having an advantageous construction.

The invention is directed on a treatment berth for supporting a patient comprising a berth board for the patient and a basis for supporting said berth board on a floor, said berth board being adjustable relative to said basis along at least two substantially perpendicular directions in order to position the patient, characterised in that said berth board is tiltable around an axis of rotation perpendicular to the longitudinal direction thereof during said adjustment.

According to the invention, at least one of the above mentioned senses of adjustment is implemented by a tilting mechanism having an axis of rotation. Therein, the axis of rotation shall be perpendicular to the longitudinal direction, i. e. perpendicular to the Y direction, so that a tilting movement around an axis parallel to the Z axis results in an X adjustment and, in case of an axis of rotation parallel to the X direction, in a Z adjustment.

Conventional linear guide means have proven to lead to a substantial technical expenditure in case of two, especially in case of three axes of adjustment being preferred according to the invention, and thus to relatively expensive constructions. Usually, multiple drives are used for the X and for the Z adjustment directions. In contrast thereto, the X adjustment and the Z adjustment can relatively easily be implemented by a tilting movement around the above mentioned axes. Thus, especially drives can be dispensed of, i. e. drives with hand manipulation in case of a manual adjustment or motor drives in other cases. It is even possible although not necessary, to use one single drive for the tilt movement around an axis of rotation. According to the invention, preferably motor drives are contemplated for all axes of rotation, however also treatment berths having manual adjustment means or in part motorised and in part manual adjustment means shall be included.

Preferably, both the X adjustment as well as the Z adjustment are implemented by a tilted mechanism according to the invention, however, substantial advantages of the invention are already achieved if only one of both adjustment senses is implemented according to the invention.

An arrangement of the axis of rotation for the Z adjustment (i. e. the axis parallel to X) near the foot end of the berth board, and further an arrangement of the axis of rotation for the X adjustment (i. e. the axis parallel to Z) on the side from the midst of the support toward the foot end with regard to the Y longitudinal direction, have proven to be especially advantageous. Thus, the adjustment results in substantial lift strokes already in the body's midst and especially at the head end. Namely, the X parallel tilting axis is, with regard to the longitudinal extension of the berth board from the foot end, approximately within 10% of the longitudinal extension, wherein the reference of 100% shall mean the total length of the berth board not taking into account an optional head support explained in further details hereunder. Similarly, the Z parallel tilting axis is preferably within 30% of the longitudinal extension from the foot end, more preferably within 25% and most preferably within 20%.

The motor drive for the Z adjustment can, in an advantageous embodiment, be a motor, e. g. an electric motor, having a coupling wheel provided on a driven axis, and a coupling belt driven by the coupling wheel. The coupling wheel and the coupling belt can e. g. be a combination of a toothed wheel and a toothed belt or of a toothed wheel and a chain. The coupling belt carries a driver, either driving the adjustable part of the treatment berth or coupled to that part of the treatment berth that is not moved during the Z adjustment. In the first mentioned case, the motor is fixed relative to the treatment board's part fixed during the Z adjustment, in the second mentioned case it is fixed relative to the treatment board's part participating in the Z adjustment. Thus, an adjustment movement in arc form can be implemented by a simple rotating drive. Further illustration is given in the exemplary embodiments.

A preferred embodiment of the X adjustment drive can be a conventional linear drive, e. g. a spindle lift drive or a rack drive being articulated at both ends, namely at one end fixed with regard to the linear movement and one end moved by the linear movement. The articulation enables the fundamentally linear drive for the tilting movement in arc form around the axis according to the invention.

A further aspect of the invention relates to a treatment board comprising, besides a berth board for supporting the body of the patient, a head support mounted to the berth board. This head support constitutes a part independent from the berth board at least in the sense that it is adjustable relative to the berth board in a vertical direction being named the Z direction in the following. This adjustment can be driven manually and also motorically.

In this aspect, the invention is directed to a treatment berth for supporting a patient, also according to one of the preceding claims, comprising a berth board for the patient and a basis for supporting said berth board on a floor, as well as head support on said berth board for supporting the head of the patient, said head support being adjustable in at least a vertical Z direction relative to said berth board in order to position the head of the patient, characterised in that a drive for said Z adjustment of said head support is mounted in said head support and that said head support can be dismounted as a module from said treatment berth together with said drive.

The invention is in this aspect based on the presence of an adjustable head support. The drive of this head support, being a manual drive, e. g. by a crank handle or an adjustment wheel, or a motor, especially an electromotor, shall be an element of the head support. I. e. the head support shall be mounted on the treatment berth and be dismountable therefrom as a separate element without separating the drive from the head support therein. The drive thus shall only be coupled with the rest of the treatment berth by signal lines or supply lines or conducts, e. g. because of being commonly supplied with the motors therein or being controlled by a common control means. The connection between the head support and the treatment berth is reduced to static releasable mounts, lines, and conducts.

The prior art has, instead of this, mounted the drive in the treatment berth, e. g. as an electromotor driving a connecting rod by a spindle gear which rod transfers the adjustment movement to the head support. This shows the disadvantage that during production a separately pre-mounted head support module to be connected with the treatment berth only by some fixing bolts or the like, can not be used. Further, the solution according to the invention shows also advantages in the maintenance or upgrade of treatment berths in that the head support can be dismounted as a complete functional unit and be exchanged by another head support because of a necessity of repair or because an update or a modification is desired.

Preferably, the vertical Z adjustability of the head support is realized by a tilting movement for which only one single drive is necessary. The tilting axis substantially perpendicular to the vertical Z direction and further substantially perpendicular to the longitudinal extension of the treatment berth can be on the side facing the treatment berth or in the form of articulation means on the treatment berth.

Further preferred is a pinion and rack drive, namely in connection with the above mentioned tilting movement. The exemplary embodiments give an illustration. A pinion and rack drive is usually more simple and less problematic than e. g. a driven spindle gear or a linear motor. Preferably, the pinion and rack drive comprises a guide for the rack itself that is rotatable in order to compensate the tilting of the rack during the tilting of the head support. Further, the rack is preferably hollow and can serve to accommodate lines or conducts between the head support and the treatment berth in a protected manner.

Principally, in this invention motor drives of the Z adjustment of the head support are preferred. This applies especially to electromotor drives. In a further preferred embodiment, these motor drives are driven in a manner adapted to the adjustment movements of the treatment berth so that especially in automatic inclination compensation of the head support is possible during tilting of the treatment berth or its berth board. This tilting support of the berth board can appear i. a. because of a vertical Z adjustment of the berth board by a tilting movement of the same and because the respective tilting axis is distant from the head support. The automatic inclination compensation enables a constant angle orientation of the head support, e. g. a constantly horizontal orientation of the head support. This is of special advantage during treatments of the patient's head.

In a further preferred embodiment, the head support comprises means for an X adjustment in relation to the berth board, preferably also by a tilting movement around an axis of rotation parallel to the Z direction. Also this adjustment is preferably done by a motor. Also, it is preferred that the X adjustment can be done in a (mechanically or motorically) adjusted manner with regard to the X adjustment of the berth board in order to enable a corresponding angular compensation in the head support during tilting X adjustments of the berth board. Then, the patient's head can be displaced in X direction without producing angular deviations in the region of the patient's head lying on the head support. On the other hand, the angular deviations appearing when disregarding this option, are not that substantial that problems must occur in all applications.

For the technical implementation of the X adjustment of the head support by a tilting movement, the explanations relating to the Z adjustment apply analogously.

When a head support mounted to a treatment berth in a modular manner according to the invention is adjusted, a risk of squeezing can result. This applies especially for a tilting up of the distal end of the head support relative to the treatment berth, wherein the upper support face of the head support is moved in direction to the treatment berth. The invention proposes to leave sufficient space in order to prohibit a risk of squeezing, especially for the treating persons. Since on the other hand, an at least substantially continuous berth surface shall be provided for the patient, it is preferred, to extend an any how advantageous cushion on the head support in order to project from its fixed parts and thus to cover such safety interspaces. As an additional measure, the cushion can be fixed on the head support simply by a surface fastener (having engaging parts) and possibly other fixing means releasable by direct pulling-off, e. g. centering pins or the like. Should the cushion squeeze, it can be released from the surface fastener and possible other fixing means in order to prohibit substantial squeezing forces.

It has been explained above that, according to the invention, both the Z adjustment and the X adjustment are realized by the above mentioned tilting movements. On the other hand, it is preferred in this invention to further realize the Y adjustment, i. e. the adjustment in the longitudinal direction, by means of a linear guide, known as such. Since the Y adjustment is not parallel to gravitation, it can be sufficient to use one single linear drive, e. g. a spindle drive, and support the berth board in a manner displaceable in the Y direction. Further, it is preferred with the invention that the Y adjustment movement relates to a locally fixed basis, and it is further preferred that the X adjustment “takes along” the Z adjustment mechanism, i. e. that the X adjustment is so to say interconnected between the Y adjustment and the Z adjustment. Thus, also the X adjustment can be free of influences of gravitation and the Z adjustment can be reduced to the movement of comparatively smaller parts of the complete treatment berth.

The treatment berth may comprise a support foot that is taken along during an X adjustment and is mounted to a part of the treatment berth distant from the axis of rotation with regard to the X adjustment, preferably in the vicinity of the shoulder or head region of the patient. Thus, during an expulsion of the X movement, an improved overall stability can be achieved due to the support foot.

A preferred application of the treatment berth according to the invention is in the field of parts of medical devices for treating the head and especially the eye. Further, the invention preferably relates to devices for treating the human body, however, it can also be used for treatment berths for animals. A further preferred application area is in laser surgery of the human eye in which by means of the treatment berth according to the invention the treated eye can be adequately positioned for a laser surgical treatment.

Finally, the invention also relates to a method for supporting a patient by means of the above described treatment berth. The above and the following description of the treatment berth with its product features is to be understood simultaneously as a disclosure of said method.

Hereunder, embodiments of the invention are described in further details, wherein the disclosed features can also be relevant for the invention in other combinations.

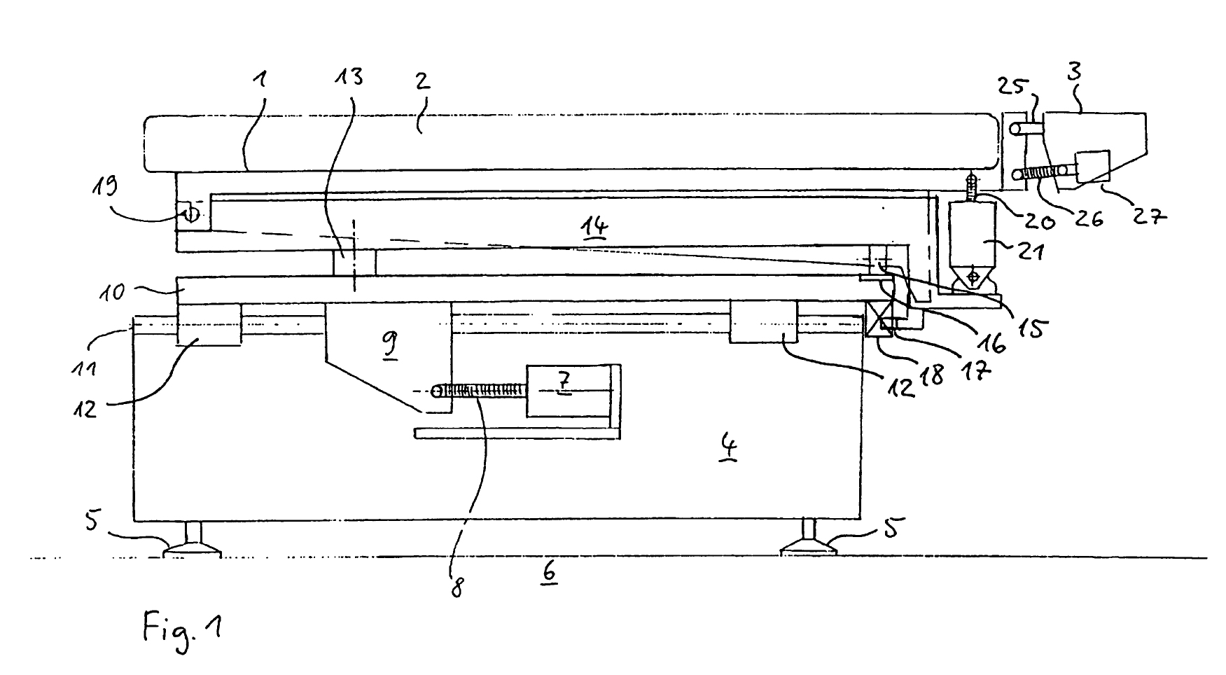

FIG. 1 shows a side view of a treatment berth according to the invention.

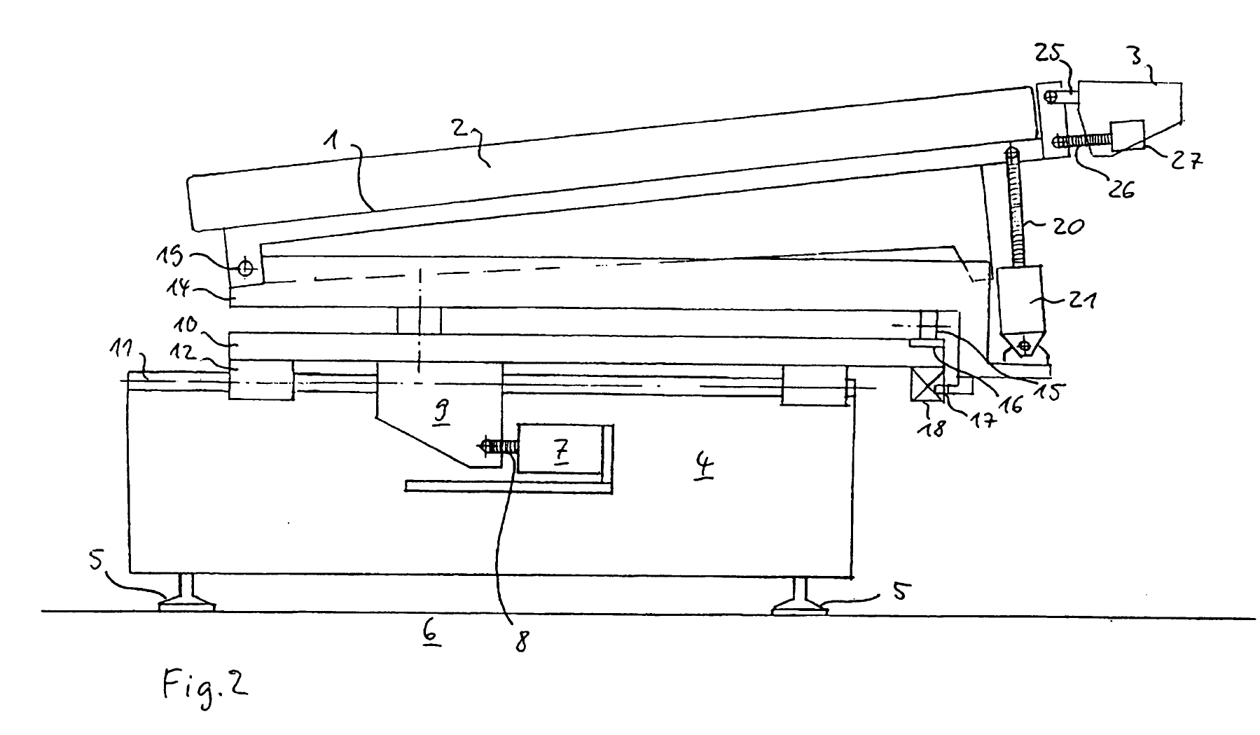

FIG. 2 shows the treatment berth of FIG. 1 having different adjustment positions.

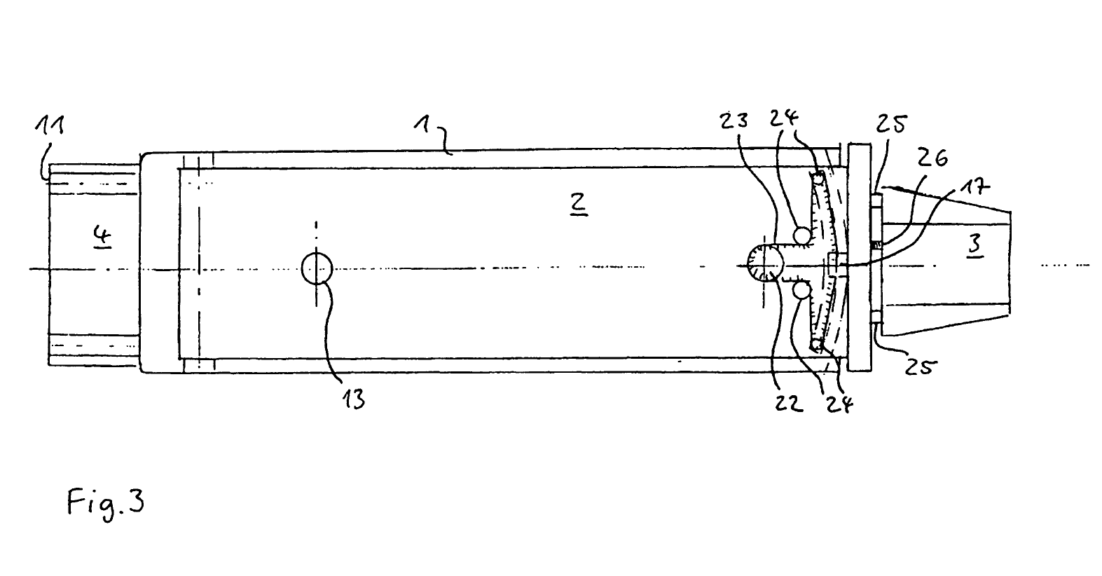

FIG. 3 shows a top view of the treatment berth according to FIGS. 1 and 2.

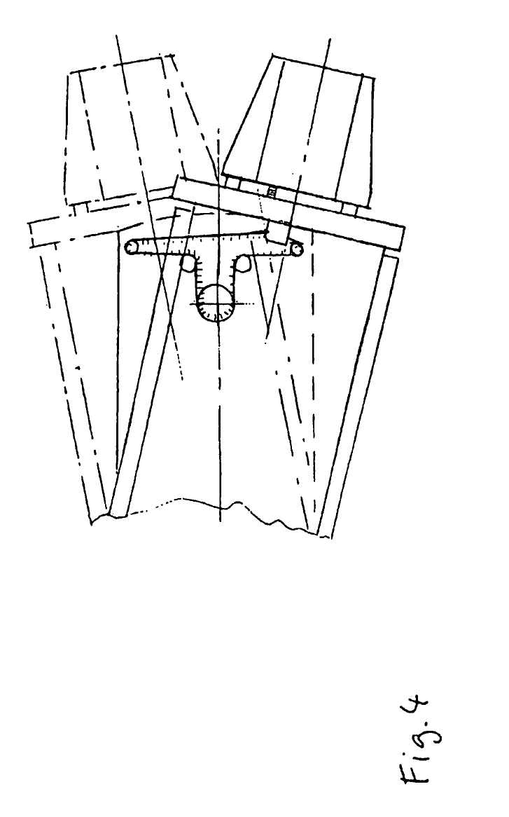

FIG. 4 shows a top view according to FIG. 3 with different adjustment positions.

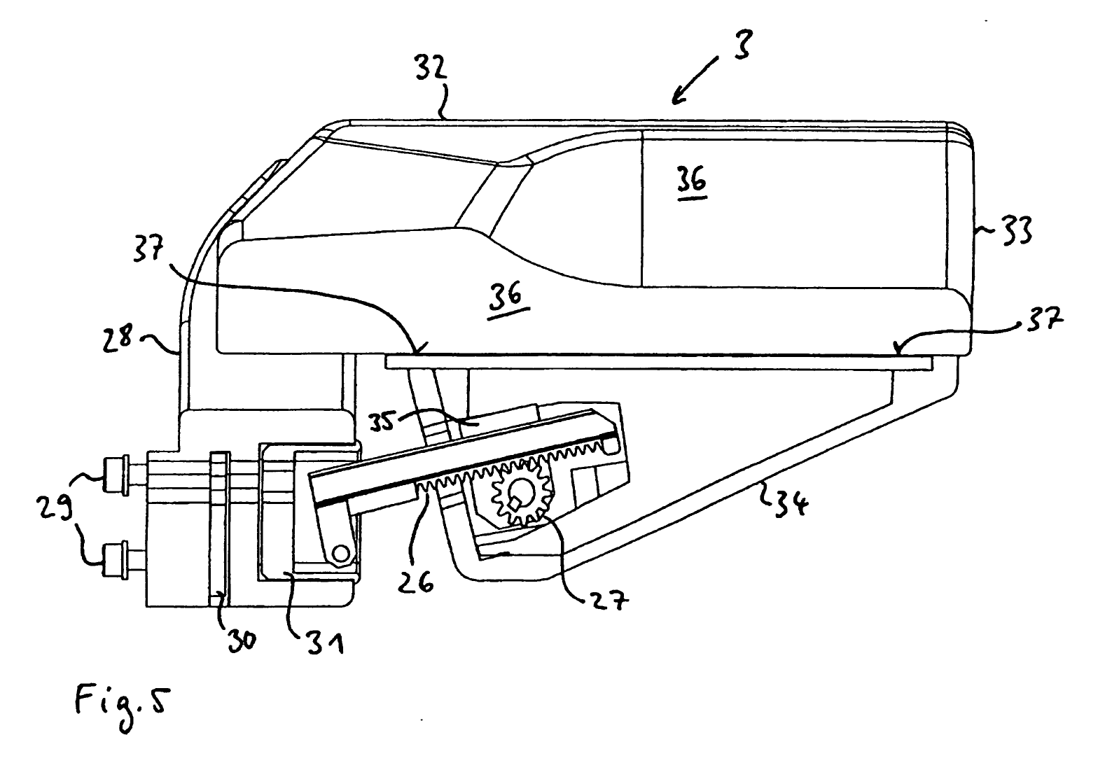

FIG. 5 shows a section through a head support of the treatment berth according to FIGS. 1-4.

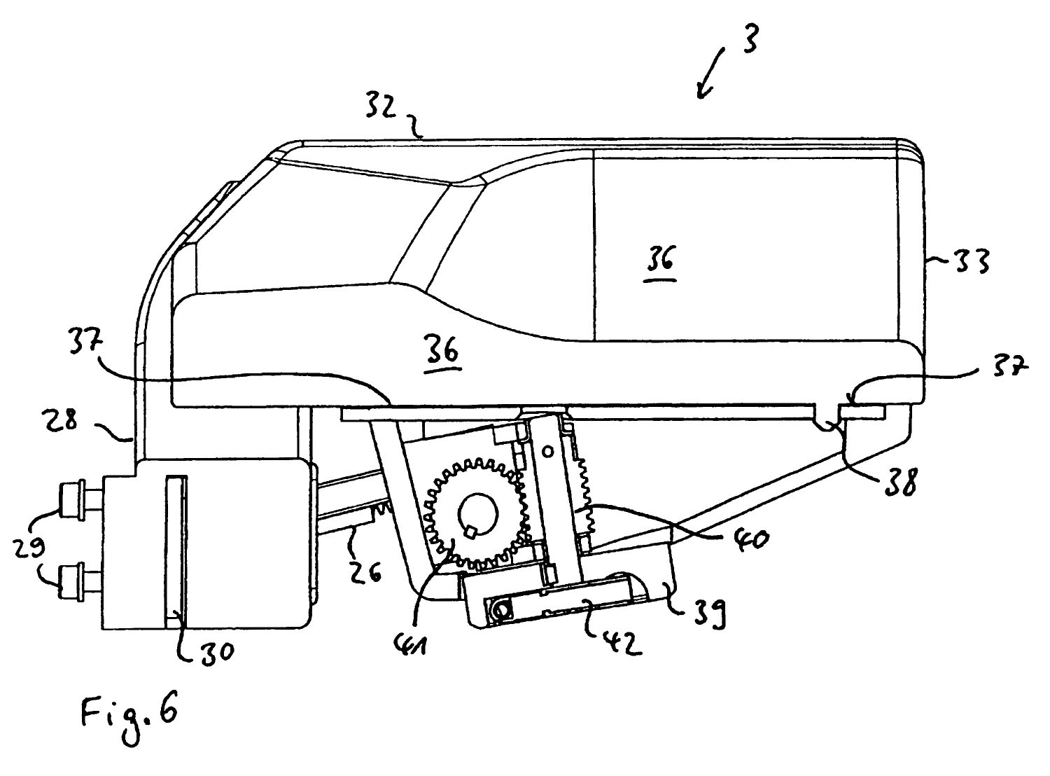

FIG. 6 shows another embodiment of the head support in a manner comparable to FIG. 5.

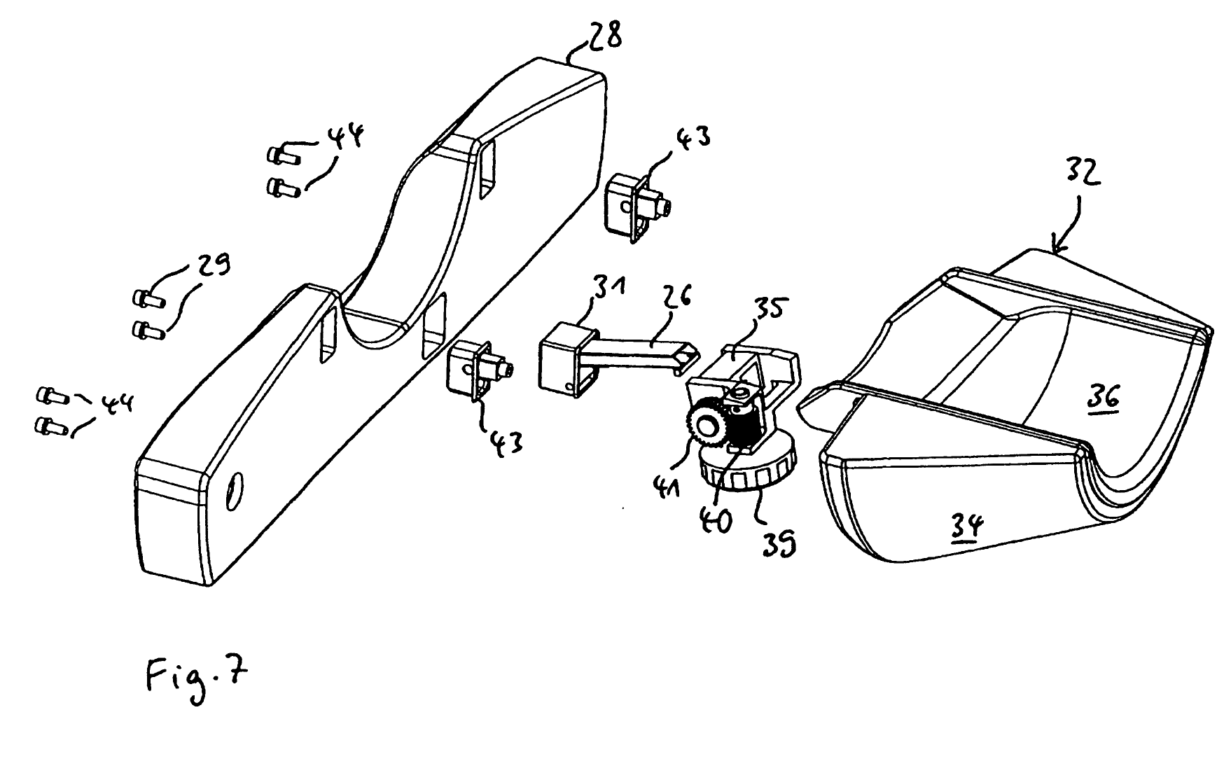

FIG. 7 shows the head support of FIG. 6 in an explosion diagram.

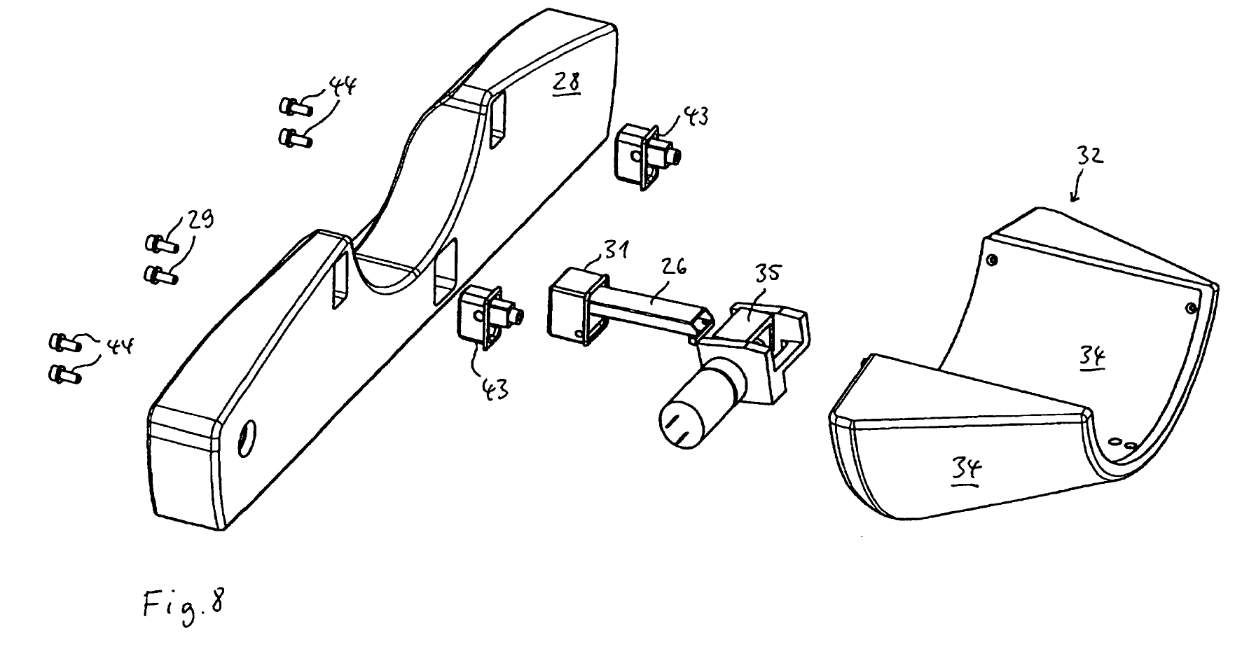

FIG. 8 shows the head support of FIG. 5 in an explosion diagram.

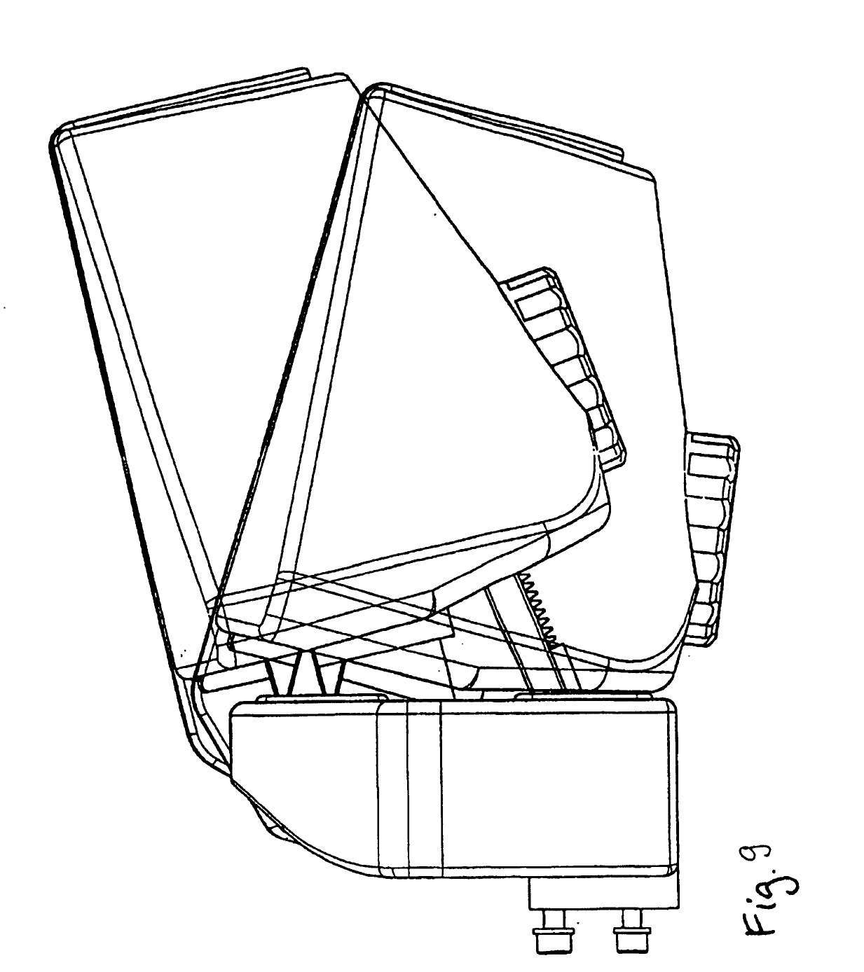

FIG. 9 shows the head support of FIGS. 6 and 7 in a side view with two different adjustment positions.

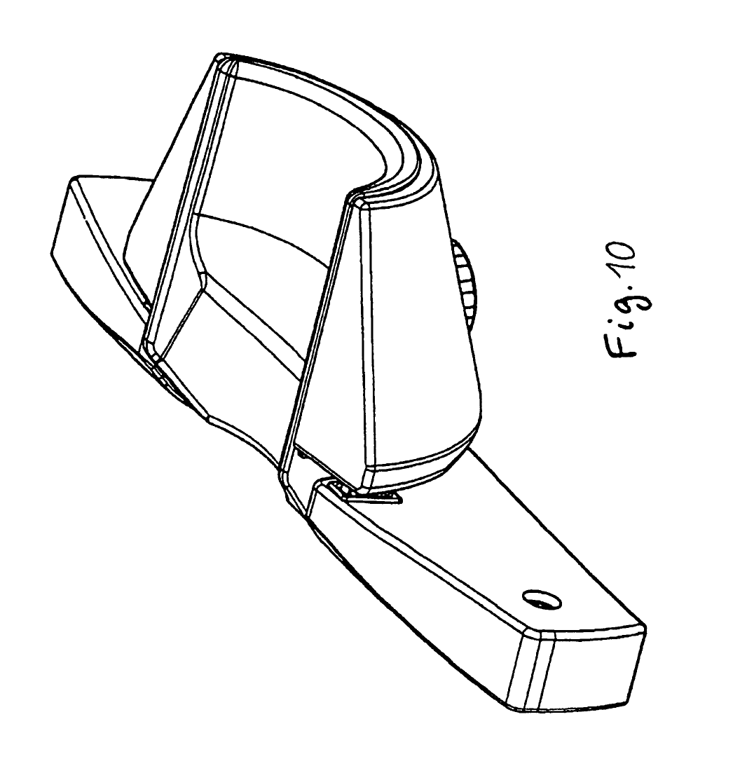

FIG. 10 shows a perspective view of the head support of FIGS. 6-8.

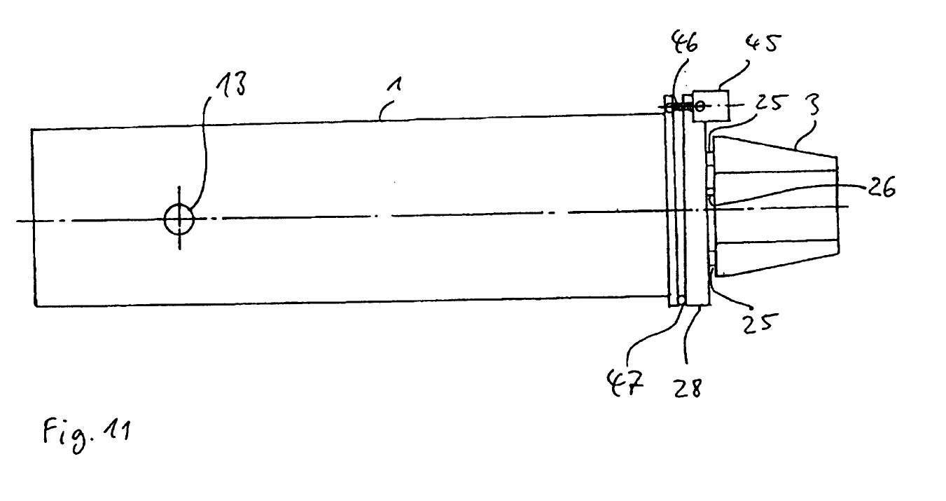

FIG. 11 shows a schematic top view of a further embodiment of a treatment berth according to the invention having an X-adjustable head support.

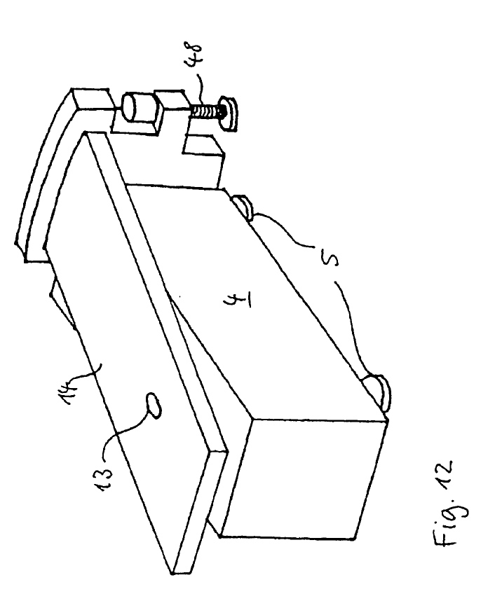

FIG. 12 shows a schematic perspective view of a still further embodiment of a treatment berth according to the invention comprising a support foot.

FIG. 1 shows a side view of a treatment berth according to the invention disclosing several relevant technical features that would not be seen from outside of a closed casing. In FIG. 1, 1 is a berth board on which a mattress 2 is supported and on the right end of which on a vertical end of the berth board 1, a head support 3 is mounted.

Berth board 1 is mounted on a basis 4 in a manner to be explained in further details, which basis is supported on a floor 6 by means of adjustable feet 5.

A linear drive comprising an electromotor 7 and a spindle lift rod 8 driven thereby is mounted in a locally fixed manner within basis 4. Spindle lift rod 8 is mounted on a console 9 by which electromotor 7 and spindle lift rod 8 can move a first intermediate board 10. First intermediate board 10 is supported displaceably by linear guides 12 running on a rail 11 in a direction horizontal in FIG. 1 and thus in the longitudinal direction of berth board 1. This direction corresponds to the Y direction.

First intermediate board 10 supports a bearing 13 having an axis of rotation vertical in FIG. 1 at approximately 17%-18% of the longitudinal extension on the side of the foot end (drawing is not to scale). By this bearing 13, a second intermediate board 14 is supported rotatably around the vertical axis relative to first intermediate board 10. Therein, second intermediate board 14 is supported on a running face 16 of first intermediate board 10 by a roll having reference numeral 15, and on the other hand is connected to a driver 17 being driven by a tooth belt to be explained in more details hereunder. The tooth belt runs within a casing having reference numeral 18 in FIG. 1. Thereby, second intermediate board 14 can be tilted around a vertical axis through bearing 13 which corresponds to an adjustment in a direction perpendicular to the paper plane, namely the X direction, in regions distant from bearing 13 in the Y direction, i. e. especially in the region of head support 3.

A rotation bearing 19 is provided on second intermediate board 14 in the foot region (at approximately 7%-8% of the longitudinal extension, drawing not to scale), on which bearing 19 berth board 1 is articulated. In the head region a spindle lift rod 20 is articulated to berth board 1, said rod being driven by an electromotor 21 in a linear manner which electromotor itself is articulated to a mounting platform of second intermediate board 14.

FIG. 2 shows a side view as in FIG. 1 but with several deviations of the adjustment positions. A comparison of FIGS. 1 and 2 shows on the one hand that by extending spindle lift rod 20 out of electromotor 21, berth board 1 is tilted around axis of rotation 19 and thus is lifted in the head region vertically, i. e. in the Z direction.

Further, a comparison of FIGS. 1 and 2 shows that by moving spindle lift rod 8, here pulling into electromotor 7, first intermediate board 10 and thus also second intermediate board 14 and berth board 1 can be moved in Y direction.

FIG. 3 shows a top view onto the treatment berth of FIGS. 1 and 2 wherein especially the mechanism for driving driver 17 is shown in more details. An electromotor 22 having an axis of rotation in the Z direction drives a tooth belt 23 guided around four deviating rolls 24 and mounted to driver 17. Rotating the axis driven by electromotor 22 thus moves also driver 17 in X direction and thus moves second intermediate board 14 relative to first intermediate board 10 in X direction. This movement is illustrated in FIG. 4 wherein continuous lines show an according to FIG. 4 lowering adjustment of the head region in X direction and broken lines show an X adjustment in opposite direction. For clarity, reference numerals are omitted in FIG. 4. The rotation is around the axis through bearing 13. A roll 15 approximately in the middle with regard to the X direction below second intermediate board 14 remains on running rail 16 continuous over the complete X width of first intermediate board 10 within the adjustment range shown in FIG. 4.

Further, the figures show that head support 3 is articulated to berth board 1 by two levers 25. FIGS. 1 and 3 further show that a further spindle lift rod 26 with an electromotor 27 is provided in Z direction below levers 25. Electromotor 27 is articulated to head support 3. Further, spindle lift rod 26 is articulated to berth board 1. A comparison of FIGS. 1 and 2 shows that by pulling in and extending of spindle lift rod 26 in and out of motor 27, a tilting movement of head support 3 around the articulation axis of levers 25 on berth board 1 results, by means of which especially an automatic inclination compensation during Z adjustment of berth board 1 can be accomplished. This inclination compensation is clearly visible in FIG. 2. Further, head support 3 can of course be tilted in other ways if desired. The automatic inclination compensation is accomplished by corresponding coordination of the control of motor 27 and motor 21.

FIG. 5 shows the head support of the berth board in details, namely in a section seen in X direction.

Head support 3 comprises a support plate 28, the detailed construction of which appears from the following figures and which can be fixed to the treatment berth by fixing bolts 29. Support plate 28 is also shown in FIGS. 1-4 symbolically but not referenced.

The fixing bolts engage a metal plate 30 having corresponding threads in order to reduced the load of support plate 28 being made of synthetic resin in the rest. Further, they support an articulation box 31 in support plate 28 in which box rack 26 already mentioned in relation to FIGS. 1-4 and shown therein is articulated.

The following figures show in more details that the very head cup 32 of head support 3 is articulated to support plate 28 via two articulation boxes above and under the paper plane having corresponding tilting levers. This head cup 32 consists of an anatomically formed upper part 33 and a casing part 34 mounted therebelow into which rack 26 already mentioned projects. An electromotor 27 arranged below the paper plane and also shown in FIG. 1 together with a driven pinion clearly shown in FIG. 5 is mounted within casing part 34. Further, a guide 35 holding and guiding rack 26 is provided, in which, however, rack 26 is displaceable. Guide 35 can be tilted around the axis of electromotor 27 and thus follow a tilting movement of rack 26 around the articulation within articulation box 31 during a movement of head support 3.

Head rest 33 consists substantially of a soft foam cushion 36 being fixed to an upper plate of casing part 34 by a surface fastener 37. In order to assist the mounting of this cushion 36, additional centring pins, not shown here, can be provided.

FIG. 5 shows that this plate is somewhat spaced from support plate 28 in the horizontal position of head support 33, i. e. does not project much over the rest of casing part 34 in the direction towards support plate 28. Thus, an interspace between casing part 34 and support plate 28 results at this place being covered by cushion 36. A risk of squeezing is thus not given since this interspace is that large that fingers of operating persons can not be squeezed easily. Further, cushion 36 which can certainly come nearer to support plate 28 during a downward movement as shown in FIG. 5, can escape upwardly. This results on the one hand from a certain deformability and, on the other hand, is an advantage of surface fastener 37.

FIG. 6 shows an alternative embodiment to FIG. 5 being mountable to a treatment berth according to FIGS. 1-4 as well. In the following, only variations in relation to FIG. 5 are discussed. First, FIG. 6 shows a centring pin 38 holding cushion 36 on the upper plate of casing part 34 of head cup 32. Further, electromotor 27 is replaced by a crank handle drive 39 having a worm gear 40, 41, here. A tooth wheel 41 of the worm gear is coaxial with a pinion for driving rack 26 corresponding to driven pinion 27 of FIG. 5.

Crank handle 39 comprises a swing-out pin for assisting the manipulation, being referenced as 42. It is shown that the manual drive is an element of head support 3 in the same way as electromotor 27 with its corresponding drive parts in FIG. 5. There are no further fundamental differences to FIG. 5.

FIG. 7 illustrates head support 3 of FIG. 6 in an explosion diagram. It is shown that cushion 36 has a somewhat half-round form and that casing part 34 of head cup 32 is adapted to this half-round form and supports cushion 36 from outside. Further, the part of cushion 36 projecting over casing part 34 and a corresponding half-round form indentation in support plate 28 into which this projecting part projects, is shown. Besides articulation box 31, FIG. 7 shows two further articulation boxes referenced as 43 and fixed by bolts 44. These articulation boxes support articulation pins to be mounted to casing part 34 of head rest 32 and on the other hand to be inserted into the shown reception holes of support plate 28 and to be fixed by bolts 44. Fixing bolts 29 and 44 further serve for fixing support plate 28 on the remaining treatment berth in a manner not shown in detail. They are screw-fixed through a board of treatment berth through support plate 28 with articulation boxes 31 and 43.

Further, FIG. 7 shows guide 35 for rack 26 and worm gear 40, 41 of FIG. 6 perspectively.

Finally, it is shown that rack 26 is a hollow tube. Thus, electrical lines can be arranged in rack 26 in a manner not shown, e. g. if an electromotoric drive 27 is used instead of crank handle 39-42.

FIG. 8 shows an analogous view to FIG. 7, however relating to the embodiment of FIG. 5. Further, in FIG. 8, cushion 36, shown in FIG. 7, is omitted for clarity reasons. Reference is made to the explanations relating to FIGS. 5-7.

FIGS. 9 and 10 show a side view of head support 3 of FIGS. 6 and 7 having a lower and an upper adjustment position and a perspective view of head support 3 for a better understanding of FIG. 7. There are no reference numerals to improve the pictorial representation.

FIG. 9 shows especially that an adjustment by crank handle 39-42 results in an upward displacement of head rest 32 in relation to support plate 28, head rest 32 therein being supported by rack 26 and articulation box 31. A downward adjustment is corresponding. It can be realised in a motorised embodiment adapted to a Z adjustment of berth board 2 of the treatment berth in order to ascertain a constant, e. g. horizontal, supporting of the patient's head. This is of special importance for an application of the treatment berth along the explanations below.

It can be seen that rack 26, or in a more general sense the longitudinal adjustment element of the drive, is arranged below the articulations forming the tilting axis. This is advantageous in that reduced longitudinal displacements due to a head support adjustment appear in the plane of the patient's head (in Y direction) and that the drive is better accessible from below for operation or for mounting and dismounting.

FIG. 11 shows a schematic diagram of a further embodiment for illustrating the optional feature of an X adjustment of head support 3. Above mentioned support plate 28 is mounted to berth board 1 having Z-parallel axis of rotation 13 for its X adjustment, in this case by a motorically driven rack 26 with a motor 45 on an outer side (seen in X direction) and by an articulation 47 on the opposing outer side. Thus, support plate 28 can be adjusted relative to berth board 1 around axis of rotation 47 so that angular deviations due to X adjustments of berth board 1 around axis of rotation 13 can be compensated. The Y deviations occurring in this example—axis of rotation 47 is not in the midst—can be compensated by an automatic compensation in the Y adjustment of berth board 1 as well, if desired. Further, the X adjustability of head support 3 can be advantageous also for other reasons.

FIG. 12 shows a further optional embodiment in which the X-adjustable part of the treatment berth is supported on the floor by an adjustable support foot 48. Support foot 48 is shown only symbolically and can be driven, practically, in order to lift from the floor during adjustment movements and to contact the floor thereafter for stabilisation. Alternatively, the lower end of support foot 48 can also have a roll rolling on the floor or a slide face. Support foot 48 is mounted on a front face plate being itself connected to already mentioned intermediate board 14, intermediate board 14 being displaceable around axis 13 relative to basis 4 itself.

The treatment berth shown is an integral element of a laser surgery device for treating visual defects of the human eye, which device is not shown in further details and is known as such. A head of this device is arranged above head support 3 and deviates a laser beam running in Z direction into the eye, which eye is to be adequately positioned by means of the treatment berth. By an X adjustment, it can be switched between both eyes of the patient. The optical adjustment features of the laser device itself need thus only cover the fine movements of the laser beam during the substantial treatment. The patient is positioned independently therefrom by the treatment berth. Especially the X adjustment can also be used to ease a mounting of the patient.

1-21. (canceled)

22. A treatment berth for supporting a patient comprising
a berth board (1) for said patient
and a basis (4) for supporting said berth board (1) on a floor (6), said berth board (1) being adjustable relative to said basis (4) in order to position said patient,
and said berth board (1) being tiltable around a first axis of rotation (19) during these adjustments which axis of rotation is arranged parallel to a direction (X) perpendicular to the longitudinal direction (Y), wherein the tilting movement corresponds to a vertical adjustment (Z), and being tiltable around a second axis of rotation (13) which is parallel to a direction (Z) perpendicular to the longitudinal direction (Y), wherein the tilting movement corresponds to a horizontal and, in relation to the longitudinal direction (Y), perpendicular adjustment (X),
wherein said second axis of rotation (13) is arranged out of the midst to the side of the foot end in relation to the longitudinal extension (Y) of said berth board (1), namely within 30% of said longitudinal extension (Y),
wherein said first axis of rotation (19) is arranged approximately adjacent the foot end in relation to the longitudinal extension (Y) of the berth board (1), namely within 10% of the longitudinal extension (Y).

23. A treatment berth according to claim 22 in which said berth board (1) is further adjustable relative to said basis (4) along a direction (Y) parallel to its longitudinal direction.

24. A treatment berth according to claim 22 in which at least one adjustment movement is driven motorically (7, 8, 20, 21, 22).

25. A treatment berth according to claim 24 in which the motor drive for the adjustment movement around the first axis of rotation (19) comprises a linear drive (20, 21) which is mounted on both ends via articulations.

26. A treatment berth according to claim 24 in which the motor drive for the adjustment movement around the second axis of rotation (13) comprises a motorically driven coupling wheel, a coupling belt (23) driven by said coupling wheel, and a driver (17) mounted on said coupling belt.

27. A treatment berth according to claim 22 in which the adjustment movement in said longitudinal direction (Y) is accomplished by an exclusively translatoric linear guide (7-12).

28. A treatment berth according to claim 22 in which a support foot take along with an adjustment movement around the second axis of rotation (13) is provided for supporting said berth board on said floor in case of an extended adjustment, and wherein said adjustment movement around said first axis of rotation (19) does not take along said support foot.

29. A treatment berth for supporting a patient comprising a berth board (1) for the patient
and a basis (4) for supporting said berth board (1) on a floor (6), as well as head support (3) on said berth board (1) for supporting the head of the patient, said head support being adjustable in at least a vertical Z direction relative to said berth board (1) in order to position the head of the patient,
characterised in that a drive (25, 26, 27, 31, 35, 39-43) for said Z adjustment of said head support (3) is mounted in said head support (3) and that said head support (3) can be dismounted as a module from said treatment berth together with said drive (25, 26, 27, 31, 35, 39-43).

30. A treatment berth according to claim 29 in which said head support (3) is tilted vertically during the adjustment around an axis of rotation perpendicular to a longitudinal direction of said berth board (1).

31. A treatment berth according to claim 29 in which said head support (3) is further adjustable relative to said berth board (1) in a substantially horizontal X direction in that it is tilted horizontally around an axis of rotation perpendicular to a longitudinal direction of said berth board (1), wherein a drive (45-47) for said X adjustment of said head support (3) is mounted in said head support (3) and that said head support (3) can be dismounted as a module from said treatment berth together with said drive (45-47).

32. A treatment berth according to claim 29 comprising a motor drive (25, 26, 27, 31, 35, 43) for the adjustment of said head support (3) having a rack gear (26, 31, 35).

33. A treatment berth according to claim 32 in which said rack gear (26, 31, 35) comprises a guide bush (35) for said rack (26) being supported rotatable relative to said head support (3).

34. A treatment berth according to claim 32 in which said rack (26) is hollow and comprises lines or conducts for said drive motor (27).

35. A treatment berth according to claim 29 in which an automatic inclination compensation of the head support is accomplished during an adjustment of said berth board (1) perpendicular to a longitudinal direction (Y) of said berth board (1) by a motoric adjustment of said head support.

36. A treatment berth according to claim 29 comprising a cushion being held by a surface fastener such that it can be released in case of a squeezing during a Z adjustment of said head support.

37. A medical device for a treatment in the head region comprising a treatment berth according to claim 29.

38. A device according to claim 37 for treating the eyes.

39. A device according to claim 38 comprising a laser surgical device.

40. A method for supporting a patient by a treatment berth of claim 22 in which the body part of the patient to be treated is positioned in an adequate treatment position by tilting a berth board (1) supporting the patient around an axis of rotation (13, 19) perpendicular to said longitudinal direction (Y) of said berth board (1).
